(19) United States
(12) Patent Application Publication
(10) Pub. No.: US 2026/0238874 A1
(43) Pub. Date: Aug. 13, 2026

(54) Artificial intelligence trail camera

(71) Applicant: Zhifeng Chen, San Diego, CA (US)

(72) Inventor: Zhifeng Chen, San Diego, CA (US)

(21) Appl. No.: 19/051,191

(22) Filed: Feb. 12, 2025

(51) Int. Cl. H04N 23/61; H04N 23/11; H04N 23/60; H04N 23/62; H04N 23/65; H04N 23/661

(52) U.S. Cl. CPC H04N 23/61; H04N 23/11; H04N 23/62; H04N 23/64; H04N 23/651; H04N 23/661

(57) ABSTRACT

This invention designs an AI-based tracking camera system for low-power, low-latency, and accurate animal recognition. The method uses the camera-side AI to identify animal categories, sizes, and features, applying a multi-threshold strategy to filter relevant animal images and push real-time notifications to the user, avoiding the upload of invalid data. This improves recognition accuracy, message push precision, and prevents unnecessary power consumption. The system consists of a tracking camera, cloud server, and user terminal, with AI deployed separately on both ends. The camera terminal can complete the identification task offline, which solves the problems of network delay, instability and user privacy protection in remote areas; the cloud terminal is equipped with an AI agent function, which provides deep analysis and intelligent interaction functions, providing users with an intelligent and reliable wildlife monitoring solution.

### TECHNICAL FIELD

The present invention generally relates to a method for reducing false detection rates and to a low-latency, low-power trail camera system, and more specification to a system for monitoring and tracking animals in a monitored space utilizing image recognition of trail camera image data.

### BACKGROUND

Trail cameras are mainly used in scenarios such as farm or yard guarding, wildlife conservation, field animal observation and research, hunting, etc. is the main tool for wildlife monitoring today. The devices in such scenarios are usually difficult to be equipped with chargers for real-time charging and wired network connection, making it difficult to use traditional constant power surveillance cameras. Therefore, when designing, in order to save power consumption, devices such as trail cameras are usually fixed in a remote location using infrared sensors to activate the camera to capture images, and after uploading the data to the cloud or retaining it in the memory via 4G network or WIFI, the camera goes into hibernation to save power consumption. This method has the advantages of low disturbance to animals, few human constraints, 24/7 and sustainability.

However, there are usually several major pain points in using the traditional trail cameras currently on the market:
1. The actual environment is disturbed by natural conditions, such as sunlight, plant shaking or raindrops, which can easily lead to PIR false triggering, and many pictures or videos taken and uploaded after triggering do not have animals, There is a very high false detection rate ;
2. Frequent uploading of a large number of images with non-targeted content consumes unnecessary camera power and reduces standby time, especially in field environments, which will lead to early camera failure;
3. Frequent uploading of a large number of pictures with non-targeted content will also lead to a sharp increase in the user's communication traffic, which will result in a waste of the user's traffic costs;
4. Frequent and useless triggering leads to a large number of pictures piling up together, in which it is difficult for the user to find the pictures he is interested in, and the later screening will also consume a lot of human resources. For example, a hunter fixes a trail camera somewhere in the forest to track the wild boars in the area, when he detects the images captured by the camera, he realizes that thousands of images have been stored in its memory, but only a few of them contain wild boars, which makes it extremely difficult and time-consuming to screen them by human resources. In recent years, the application of deep learning in the field of image recognition has made significant breakthroughs, with more successful cases in the recognition of some mammals and other species. In order to solve the above problem of PIR false triggering that causes the camera to save a large number of redundant images, an effective solution is to combine the trail camera with a cloud-based artificial intelligence model. Specifically, when the camera captures an image, it can be sent to a cloud-based artificial intelligence model for animal recognition detection. This way the next step of processing and storing will only be done when there is indeed a target in the image that needs attention, thus reducing the generation of redundant images. However this solution is more than a traditional trail camera, and new problems inevitably arise due to the need to upload image data to the cloud for artificial intelligence processing:
1. high network latency, does not have the ability to drive animals in real time, in the yard, farm care and other scenes that require low latency can't work well;
2. the camera still needs to upload all the pictures taken after triggering to the cloud for processing, and the power consumption of the camera will not be reduced compared to traditional cameras;
3. the camera still needs to upload all the pictures taken after the trigger to the cloud, the waste of user traffic costs is still not alleviated, and because the cloud artificial intelligence usually needs to recognize the results of the feedback to the camera or the user terminal, it will generate more traffic costs;
4. In areas with low network coverage, the network is unstable and the user's experience will not be guaranteed;
5. There is a potential risk of uploading to the cloud data containing user privacy, which may contain sensitive information such as the user's location;

Therefore, the development of a trail camera with the ability to accurately recognize animals offline, reduce false triggers, and accurately push images of interest to the user is an important challenge in current technology.

### SUMMARY

An object of the present application is to provide an artificial intelligence trail camera with low latency and low power consumption. The trail camera provides an artificial intelligence-based animal shooting method that reduces the false detection rate and a low-power, low-latency trail camera system, so that the trail camera can utilize the artificial intelligence processing unit locally carried by the camera to intelligently identify in real time whether the object currently in the infrared sensing area belongs to the animal category required by the user, and thus determine whether the image currently captured by the camera needs to be uploaded to a cloud and transmitted to the user, and whether it needs to emit sound and light to repel it, achieving the purpose of low latency and low power consumption. The camera can determine whether the image captured by the camera needs to be uploaded to the cloud and transmitted to the user, and whether it needs to send out sound and light to drive away, so as to achieve the purpose of low delay and low power consumption.

In a first aspect, the present application provides a method for photographing an animal based on artificial intelligence to reduce the false detection rate, applied to an intelligent trail camera, the method comprising:

When a new active animal is determined to have entered the infrared sensing area an image capturing unit connected to the central processing unit is activated to take a picture and capture the low-pixel image data. In addition, the central processing unit is used to transmit the low-pixel image data captured by the image capture unit to the artificial intelligence processing unit for intelligent recognition and analysis. The artificial intelligence processing unit utilizes a local artificial intelligence model equipped inside the camera to quickly identify the image content and obtain an identifiable category of animals in the captured image as well as a trustable score value; the trustable score value may be set with a plurality of thresholds Th0,Th1 . . . Thn wherein n is greater than 1. According to the relationship between the trustworthiness score and the threshold value, the probability that the animal in the image belongs to a certain category is judged, so as to determine whether the trail camera exits the shooting mode and enters the dormant mode to save power, whether the image is uploaded to the cloud to use the cloud artificial intelligence processing unit to continue detecting, and whether the image is saved to the memory. Ensure that only animals whose currently recognized categories match the categories set by the user are present in the image to be filtered for transmission.

In the above method, after said tracking camera senses a new active animal in the infrared sensing area, it will not directly start saving the acquired high pixel images, but will first start taking low pixel pictures to acquire the first M frames. In this first M-frame image captured, the movement trajectory of the animal is analyzed by an artificial intelligence model to extract multi-scale features related to the animal. The multi-scale features include, but are not limited to, key parameters such as the animal's category trustworthiness, body size, walking speed, etc., which together form a trustworthiness score that is evaluated in multiple dimensions to more accurately distinguish target animals from non-target animals and reduce the possibility of false detection. For example, for some common animals (e.g., birds, small mammals), their body size and locomotor characteristics are significantly different from those of the target animals (e.g., large mammals), so the model can effectively avoid the false detection of non-target animals. In addition, the analysis of multi-frame data can also help the model observe the animal behavior from more angles, avoiding the misdetection phenomenon triggered by single-frame data.

The trustable score is set with a plurality of thresholds Th₀,Th₁ . . . Thₙ, where n is greater than 1. According to the relationship between the trustable score and the thresholds, the probability that an animal in the image belongs to a certain category is judged. The classification of probability includes but not limited to high probability, uncertain probability, low probability. When the artificial intelligence model gives the trustworthy score of the animal in the image belonging to the high probability of this animal, the high pixel image is saved, the tracking camera stops shooting, and according to the user settings decides whether or not to upload to the cloud server, and the camera enters into hibernation; belonging to the low probability of this animal, the tracking camera stops shooting and enters into hibernation; belonging to the uncertainty of the probability of this animal, it formally enters the shooting mode continuing to shoot.

The shooting modes are divided into photo mode and video mode. When the shooting mode is the photo mode, the photo function is performed when the artificial intelligence model gives a high probability that the trustworthiness score of the animal in the image belongs to this animal, and the high-resolution image is saved to the memory, and when the shooting mode is the video mode, the video function is performed when the artificial intelligence model gives a high probability that the trustworthiness score of the animal in the image belongs to this animal.

The above if the user sets the decision to upload to a cloud server to continue the detection using the cloud AI processing unit includes, but is not limited to, the following: when the user turns on the cloud AI detection function, the system can also upload the captured images to the cloud after the camera's built-in AI model has completed the initial processing in order to use the cloud's powerful computational resources and the finer AI model to perform a secondary detection. This process allows for in-depth analysis of the images using higher precision and more sophisticated AI models to further confirm the animal's category, characteristics and behavioral patterns. If the user sets not to use cloud-based models, no detection is performed.

In a second aspect, the present application provides a trail camera system with low latency and low power consumption, the trail camera said system includes but is not limited to:

A trail camera having an image capture function, carrying an artificial intelligence processing unit configured to be capable of monitoring a target area, capable of capturing at least one of an image or audio data stream, and transmitting a continuous sequence of images of said target or area comprised in said data stream to the artificial intelligence processing unit; a cloud server connected to said tracking camera via a communication network and equipped with an independent artificial intelligence processing unit, said cloud server being configured to receive a data stream sent by said tracking camera and pass the received data stream to its own equipped artificial intelligence processing unit for inferencing; a terminal device configured to be able to communicate effectively with the trail camera and the cloud server, and to be able to receive a real-time message notification of target object-related data from said cloud server or said camera, wherein said target object related data includes, but is not limited to: at least one frame of image data from a data stream captured by said camera, information such as a category of an animal, a size of an animal, a location of an animal, a trajectory of an animal, and the like.

In addition, embodiments of the present application provide a computer program, an artificial intelligence model product comprising instructions that, when the computer program product is run on a trail camera, causes the trail camera to perform a method as described in the above-described embodiments.

Compared to the prior art, the present application has the following beneficial effects:
1. After sensing a new animal in the infrared sensing area, the trail camera captures M consecutive frames, and by acquiring the motion trajectory of the previous M frames, it recognizes the animal's category, size, and other multiscale judging features to help determine whether it is the target animal, so as to reduce the misdetection rate of the artificial intelligence model; multiple thresholds are set to enable it to adapt to different environments and different animal species, for example, in nighttime or rainy days, the judging criteria of trustworthiness scores can be appropriately relaxed, while in clear environments the criteria can be increased, so as to reduce the misdetection rate of animals; after the camera itself is equipped with the artificial intelligence model processing, it can still upload the images to the cloud using cloud artificial intelligence models. Trustable score judgment standard, while in a clear environment can raise the standard, so as to reduce the animal misdetection; in the camera itself is equipped with the artificial intelligence model processing, the image can still be uploaded to the cloud using the cloud artificial intelligence model for secondary detection, more accurate intelligent analysis, further screening out potential misdetection of the image to reduce the misdetection rate;
2. Through the artificial intelligence model equipped in the camera itself, it screens out the pictures that the user is interested in according to the recognition results for uploading to the cloud or the user's terminal equipment, and excludes the pictures that do not belong to the target content, which greatly reduces the frequency of communication between the camera and the server in the cloud, and saves the camera's power consumption;
3. Avoiding the uploading of unnecessary images reduces the frequency of communication between the camera and the cloud server, and also saves the user from unnecessary traffic consumption and high user traffic costs due to frequent uploading of useless images;
4. With the results of artificial intelligence model analysis, data such as animal name, location, time, temperature, etc. are analyzed to automatically generate animal behavior trajectories and behavioral habits, providing intelligence information for hunting, animal research and other scenarios. Images or videos can also be searched by animal name to help users quickly find the wildlife images or videos they are interested in, realizing an efficient and convenient image browsing experience;
5. Provide intelligent guarding mode, when the camera infrared sensing area detects that there is a user-set target to repel animals, due to the real-time processing capability of the camera's local model, no need to wait for the feedback of the cloud artificial intelligence model, can timely use the sound and light expulsion equipment carried by the camera to automatically emit sound and light that the animal is disgusted with, and repel the animal;
6. Compared with the traditional camera with cloud model only, only the image data that meets the user's requirements is transmitted to the cloud or the user's terminal equipment, which significantly reduces unnecessary data transmission and solves the problems of camera power consumption and high traffic costs that still exist after the introduction of the cloud AI model;
7. Allowing users to autonomously choose to perform AI inference on camera-side, cloud-side, or both provides flexibility and enables adaptive inference processing based on user needs or operational requirements;
8. In areas with low network coverage, the camera device is still able to perform intelligent image recognition for the user due to the camera's own artificial intelligence model, still providing a good user experience that is not affected by network fluctuations;
9. The camera itself has an artificial intelligence recognition function, which can effectively avoid uploading sensitive data containing user information to the cloud and protect user privacy;
10. For the first time in the trail camera products to achieve the white-tailed deer, moose, reindeer, U.S. bison, U.S. black bears, gray wolves, mountain goats, wild boars animal category detection and identification functions.

### DESCRIPTION OF DRAWINGS

FIG. 1 is a diagram of an overall system framework of a low-latency, low-power artificial intelligence trail camera disclosed in this embodiment;

FIG. 2 is a schematic diagram of a structure of a low-latency, low-power artificial intelligence trail camera disclosed in this embodiment;

FIG. 3 is an example flowchart of an artificial intelligence trail camera with low latency and low power consumption disclosed in this embodiment;

FIG. 4 illustrates image data consistent with some embodiments the present disclosure;

FIG. 5 illustrates additional image data consistent with some embodiments the present disclosure.

### DETAILED DESCRIPTION

In order to make the purpose, technical solutions and advantages of the present application clearer and more understandable, the present application is described in further detail hereinafter in conjunction with the accompanying drawings and embodiments. It should be understood that the specific embodiments described herein are only for the purpose of explaining the present application and are not intended to limit the present application.

The technical solutions of the present application are hereinafter described in detail in conjunction with the accompanying drawings.

The terms used in the following embodiments of the present application are used only for the purpose of describing a particular embodiment and are not intended to be a limitation of the present application. As used in the specification and appended claims of this application, the singular expressions “a”, “”, “the”, and “this” are intended to include plural expressions as well, unless the context clearly indicates otherwise. It should also be understood that the term “and/or” as used in this application refers to and encompasses any or all possible combinations of one or more of the listed items.

Hereinafter, the terms “first”, “second” are used for descriptive purposes only, and are not to be understood as implying or suggesting relative importance or implicitly specifying the number of technical features indicated. As a result, the feature defined with “first”, “second” may expressly or implicitly include one or more such features, and in the description of the embodiments of the present application, unless otherwise specified, “more than one” means two or more features.” in the description of embodiments of the present application, unless otherwise indicated, means two or more.

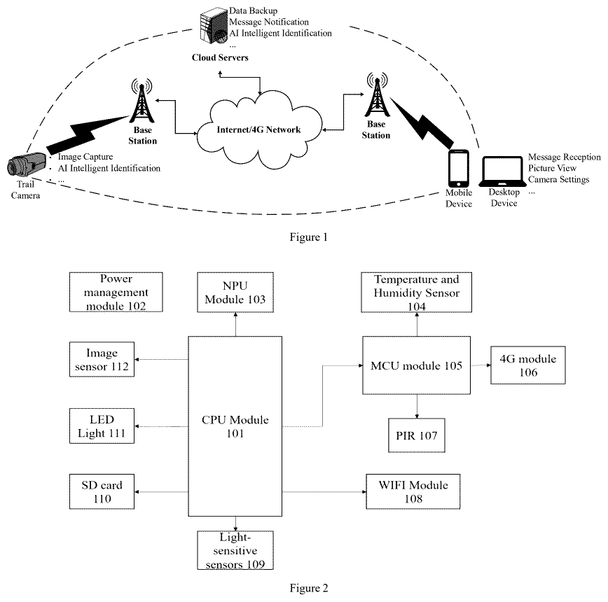

The following describes an artificial intelligence trail camera system with low power consumption and low latency provided by embodiments of the present application, FIG. 1 is a schematic diagram of a system structure of an artificial intelligence trail camera embodiment with low power consumption and low latency provided by embodiments of the present application.

Specifically comprising:

As shown in FIG. 1, the system is provided with a trail camera having an image capture function, carrying an artificial intelligence processing unit configured to be capable of monitoring a target area, capable of capturing at least one of a stream of image or audio data, and transmitting a continuous sequence of images of target or area comprised in stream of data to the artificial intelligence processing unit; and a cloud server connected to said tracking camera via a communication network and equipped with an independent artificial intelligence processing unit, said cloud server being configured to receive a data stream sent by said tracking camera and pass the received data stream to its own equipped artificial intelligence processing unit for inferencing; a terminal device configured to be able to communicate effectively with the trail camera, the cloud server, and to be able to receive data related to target objects from cloud server or camera, wherein real-time message notification of target object-related data includes, but is not limited to, at least one frame of image data from a data stream captured by camera, information such as the category of the animal, the size of the animal, the location of the animal, the trajectory of the animal, and the like.

The following describes a low-power, low-latency artificial intelligence trail camera product 100 provided by embodiments of the present application, which is subsequently replaced by the abbreviation trail camera 100. FIG. 2 is a schematic diagram of a product structure of an embodiment of a low-power low-latency artificial intelligence trail camera provided by embodiments of the present application.

It should be appreciated that the trail camera 100 may have more or fewer components than shown in the figures, may combine two or more of the components, or may have different configurations of components. The various components illustrated in the figures may be implemented in hardware, software, or a combination of hardware and software including one or more signal processing and/or specialized integrated circuits. The systems, methods, and techniques described may be implemented in digital electronic circuits, computer firmware, software, or combinations of these elements, and devices implementing these techniques may include appropriate input and output devices, computer processors, and computer program products.

It is to be understood that the interface connection relationships between the modules illustrated in the embodiments of the present application are merely schematic illustrations and do not constitute a structural limitation of the trail camera 100.

Specifically included:

As shown in FIG. 2, trail camera 100 has a CPU module 101 and an MCU module 105, and the CPU module 101 and the MCU module 105 together form a central processing unit of the trail camera 100, which controls the cooperative work among the components of the trail camera 100 by means of commands.

As shown in FIG. 2, trail camera 100 has a communication interface including a 4G module 106 and a WIFI module 108, communication module is used for wireless communication connection with external devices, and the wireless communication capability ensures instantaneous information exchange with the external devices, both in the vast field environment and in the scenarios requiring remote operation.

As shown in FIG. 2, trail camera 100 has a power management module 102, and the power management module 102 is responsible for providing the necessary electrical power to the entire trail camera 100 system, enabling the trail camera 100 to operate continuously for wildlife monitoring and identification.

As shown in FIG. 2, trail camera 100 has an artificial intelligence processing unit NPU module 103, and in order to enable the trail camera 100 to have the ability to intelligently recognize animals, the deep learning model used for the inference of NPU module 103 uses a dataset collected through a network gallery as well as a field shooting, which contains a plurality of wildlife categories, and will be updated and upgraded on a regular basis. It is to be noted that the dataset used by the deep learning model comes from diversified ways, including web galleries and field shooting collection, and each species is screened from different angles and environmental conditions to ensure that the model can still correctly recognize multiple wildlife categories in complex scenarios. In order to maintain and improve the accuracy and adaptability of the model, it is regularly updated and upgraded to incorporate new wildlife species, features, and behavioral patterns to continually optimize the recognition capabilities of the trail camera. This continuous data updating and model upgrading strategy ensures that the trail camera 100 is advanced and reliable in wildlife identification, enabling it to adapt to changing field environments and user needs.

As shown in FIG. 2, trail camera 100 may realize the function of capturing image data by means of an image capturing unit, i.e., an image sensor 112.

As shown in FIG. 2, trail camera 100 has a memory SD card 110 module for storing photos or videos taken by the trail camera 100.

As shown in FIG. 2, trail camera 100 has a pyroelectric infrared sensor PIR107 module for sensing whether there is a newly emerging infrared heat source in the active area, thereby triggering the photo or video recording function of the trail camera 100.

As shown in FIG. 2, trail camera 100 has an environment sensing and assisting device including a temperature and humidity sensor 104, a light-sensitive sensors 109, and an LED light 111, temperature and humidity sensor 104 being used to detect the temperature and humidity of the external environment and provide it to the user, and light-sensitive sensors 109 being used to detect the external environment and trigger CPU module to turn on LED light 111.

The following is a specific description of a shooting method of a low-power, low-latency artificial intelligence trail camera in an embodiment of the present application, in conjunction with the hardware structure of the above example trail camera 100 and an artificial intelligence model pre-deployed in such trail camera 100:

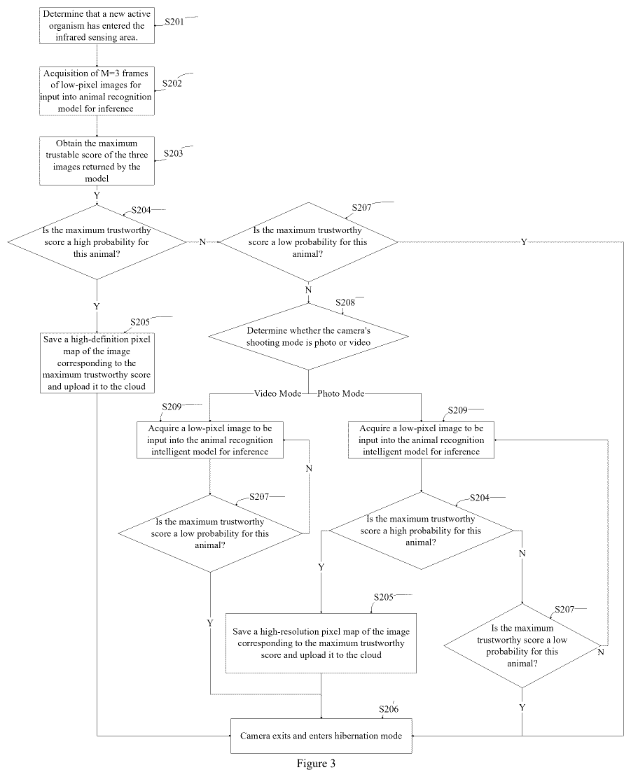

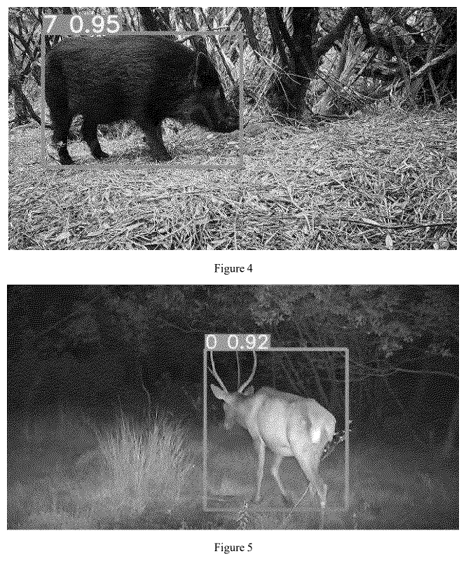

Referring to FIG. 3, an example flowchart of an artificial intelligence trail camera with low power consumption and low latency disclosed in this embodiment is shown.

S201, determine that a new active animal has entered the infrared sensing area;

The trail camera 100 may use a pyroelectric infrared sensor PIR 107 to sense the presence of a new thermal energy source within the current infrared sensing area, and when a human or animal enters the sensing area and the infrared radiation emitted by them is detected by the PIR sensor resulting in a change in the intensity of the infrared radiation received by the detecting element, a determination is made that there may be a new active animal entering the sensing area.

S202, Three frames of low-pixel images are captured and input into the animal recognition intelligent model for inference;

The trail camera 100, upon detecting a new active animal entering the sensing area, initiates an internal process within the camera to capture three frames of low-pixel images as input via the image sensor 112 to be fed into the animal recognition for inference. The reason for using low-pixel images as input to the animal recognition intelligent model for inference is to speed up model inference while saving camera power consumption.

S203, Obtain the maximum trustable score of M images returned by the model, taking M=3;

The artificial intelligence model outputs key parameters such as the animal's category trustworthiness, body size, and walking speed. These features will work together to generate trustworthiness scores that are evaluated across multiple dimensions to more accurately distinguish between target and non-target animals, thereby reducing the likelihood of false detection. The final model outputs three trustworthiness scores, corresponding to three images, and the one with the largest trustworthiness score is taken as the final result.

S204, whether the maximum trustable score is a large probability for this animal;

Two thresholds are set within the trail camera, respectively Th0, Th1. when the maximum trustworthy score is greater than Th0, it is determined that there is a high probability that this is the animal, and step S205 is executed, otherwise step 207 is executed.

S205, Save the high-definition pixel map of the image corresponding to the maximum trustworthy score and upload it to the cloud;

When the current infrared sensing area is judged by the animal recognition intelligent model to have a high probability of the appearance of this animal, the high-definition pixel map of the image corresponding to the maximum trustworthy score will be saved to the SD card 110 and the image data will be uploaded to the cloud, and at the same time, the trail of the successful recognition of the target will be pushed through the SMS mail and other channels directly or through the cloud backup of the architecture shown in FIG. 1, and then push the message of the time, the location, the animal category, and the size, etc. to any communicable user terminal device such as a user's cell phone or ipad, and the user can also view the pushed animal pictures of interest through an APP.

The purpose of saving the high-definition image is to enable the user to clearly view the image of the active animal that enters into the infrared sensing area, and further determine the active animal category with the assistance of the animal recognition intelligent model.

S206, the camera exits and enters the hibernation mode;

After the trail camera 100 successfully pushes a message to the user, it exits the current process to save power and enters hibernation mode, waiting for the next PIR107 trigger to wake up.

S207, whether the maximum trustable score is a small probability for this animal;

When the maximum trustable score is less than Th1, it is determined that there is a small probability for this animal, and step S206 is executed, otherwise step S208 is executed.

S208: Determine whether the camera shooting mode is photo or video;

The trail camera 100 has a picture-taking mode and a video-taking mode, and performs a subsequent filming process according to the filming mode set up with the

S209, Acquire a low-pixel image to be input into the animal recognition intelligent model for inference;

When the trustworthiness score of the first three frames is between the threshold Th0 and the threshold Th1, the trail camera 100 continues to acquire low-pixel images at 15 frames per second from the image sensor 112 and feeds them to the animal recognition intelligent model for inference, so as to determine the category of the animal that is currently entering the infrared sensing zone. The reason for acquiring only the low-pixel images instead of the high-pixel images is that this can greatly save power and improve the endurance of the trail camera 100, and also save the storage space of the SD card 110 of the trail camera 100 for storing more captured animal content of interest to the user in the case of satisfying the acquisition of the research information of the target object.

In the embodiment of the present application, when the trail camera senses a new animal activity in the infrared sensing area, the system does not immediately activate the high-pixel image saving function, but first shoots and acquires the first M frames of images in low-pixel mode. By analyzing these M-frame images, the artificial intelligence model will extract key parameters of the animal such as the animal's category trustworthiness, body size, and walking speed. These features will work together to generate a trustworthiness score that will be evaluated across multiple dimensions to more accurately distinguish between target and non-target animals, thereby reducing the likelihood of false detection. When the trustworthiness score reasoned by the model indicates that the animal in the image is likely to be the target animal, the system will activate the high pixel image saving function and put the trail camera into hibernation; if the model judges that the animal is less trustworthy, the camera will likewise go into hibernation mode and not take pictures. Only when the trustworthy score shows that the animal in the image has a certain probability to be the target animal, the system will enter the shooting mode. In the photo mode, when the trustworthiness score is high, the system will take a photo and save the high pixel image to the memory; in the video mode, only when the trustworthiness score is high, the system will activate the video recording function, but will not save the high pixel image.

The above is a better embodiment of the present invention, all changes made in accordance with the technical program of the present invention, the resulting function does not exceed the scope of the technical program of the present invention, are within the scope of protection of the present invention.

### REFERENCES

Li S, McShea W J, Wang D J, et al. A direct comparison of camera-trapping and sign transects for monitoring wildlife in the Wanglang National Nature Reserve, China[J]. Wildlife Society Bulletin, 2012, 36(3): 538-545.
US20190012535A1, Jason Dorr Collins, “TRAIL CAMERA IMAGE RECOGNITION SYSTEM”, United States, Jan. 10, 2019.
US20150077551A1, Kristin Simeroth, “TRAIL CAMERA”, United States, Mar. 19, 2015.

Deb D, Wiper S, Gong S X, et al. Face recognition: primates in the wild[C], 2018 IEEE 9th International Conference on Biometrics Theory, Applications and Systems, Oct. 22-25, 2018, Redondo Beach, CA, USA. New York: IEEE Press, 2018: 18619856.

US20210127055A1, Allison Beach, “INTELLIGENT SELF-POWERED CAMERA”, United States, Apr. 29, 2021.

The invention claimed is:

1. An artificial intelligence based method for reducing the false detection rate of animal photography, applied to a smart trail camera, characterized in that method comprising:
The trail camera accurately captures wildlife activity through its built-in infrared sensor, and after determining that a new active animal has entered the infrared sensing area, activates the image capturing unit connected to the central processing unit to take a picture. In addition, said central processing unit is also used to transmit the image pixel data captured by the image capturing unit to an artificial intelligence processing unit for intelligent recognition and analysis. Said artificial intelligence processing unit utilizes a pre-trained artificial intelligence model to quickly identify the content of the image, obtain the categories of animals that can be identified in the captured image, and calculate a trust score; said trust score is set with a plurality of thresholds Th₀,Th₁ . . . Thₙ wherein n is greater than 1. According to the relationship between the trustworthiness score and the threshold value, the probability that the animal in the image belongs to a certain category is judged, so as to determine whether the trail camera exits the shooting mode and enters the dormant mode to save power, whether the image is uploaded to the cloud to use the cloud artificial intelligence processing unit to continue detecting, and whether the image is saved to the memory, and the relationship between the trustworthiness score and the threshold value includes, but is not limited to:
If the trustable score is greater than Thₖ₊₁ (high probability, k+1≤n): the probability that the animal belongs to the category is high, the trail camera exits the shooting mode and enters into the sleep mode to save power, save the image locally, or upload the image to the cloud if the user has set it to be uploaded to the cloud;
If the trustable score is between Thₖ−k and Thₖ₊₁ (uncertain probability): the probability that the animal belongs to the category is medium, the trail camera continues to shoot and transmit the image to the AI processing unit for inference, if the user has set up the cloud intelligent processing, at the same time, transmit the image to the cloud for the second inference, until the trustable score obtained is high probability or low probability;
If the trustable score is less than Thₖ (low probability): the probability that the animal belongs to the category is low, the trail camera exits the shooting mode and directly enters into the sleep mode to save power, and does not upload the image to the cloud;
Ensure that only when the AI processing unit recognizes the presence of an animal in the image that matches the category set by the user will it be filtered for transmission.

2. The method of claim 1, wherein the trail camera obtains the category of the animal recognizable in the captured image and the trustworthiness score before further comprising:
The trail camera, before entering the shooting mode, first acquires M frames of low-pixel images captured by the image sensor after the infrared sensor is triggered, wherein M is greater than 1, and feeds them to said artificial intelligence processing unit for analysis; the artificial intelligence processing unit analyzes the M frames of images based on a preset artificial intelligence model and generates at least one return parameter indicating the results of the algorithms for target detection, tracking, etc. ; said return parameter include, but are not limited to, a maximum trustworthy score obtained in the M-frame image.

3. The method of claim 2, wherein the trustable score includes, but is not limited to, key parameters such as the animal's category credibility, body size, walking speed, and so on, which together comprise the trustable score.

4. The method of claim 1, wherein the filtering transmission about ensuring that only wild animals whose current identification category matches the category set by the user are present in the image comprises, but not limited to: obtaining a category of concern rule set by the user, wherein traceability camera, after detecting the presence of an animal in the infrared sensing area, determines, based on the presence or absence of the category of the animal of concern set by the user in the category of animals returned by the artificial intelligence model, whether to saved to memory or pushed a message to the user through the network and uploaded to the cloud. Based on whether the animal category returned by the artificial intelligence model appears in the animal category of interest set by the user, determining whether to save it to memory or push the message to the user through the network and upload it to the cloud.

5. The method of claim 4, wherein the content of the information pushed to the user includes, but is not limited to, textual information providing the time and place of capture, the category and size of the animal, and current image information of a particular type of animal specified by the user.

6. The method of claim 4, wherein the way of pushing information to the user includes but is not limited to pushing information to the user's device side directly through trail camera, pushing information to the user's device side after backing up through the cloud, and channel of pushing information includes but is not limited to text message, email, and notification of a mobile app.

7. The method of claim 5, wherein the class of animals includes, but is not limited to, white-tailed deer, moose, reindeer, American bison, American black bear, gray wolf, mountain goat, wild boar, and the like.

8. The method of claim 1, wherein the trail camera uploads the image to the cloud to use the cloud artificial intelligence processing unit to continue the detection as: the trail camera and the cloud server are deployed with the local model and the cloud model respectively, if the user is set to use the cloud model, the local model of the trail camera is responsible for completing the preliminary detection in real time, and the cloud model can then perform the in-depth analysis; if the user is set not to use the cloud model, the detection will not be carried out.

9. An artificial intelligence trail camera system with low latency and low power consumption, wherein the trail camera system comprising, but is not limited to:
A trail camera with image capture capability, carrying an artificial intelligence processing unit configured to be capable of monitoring a target area, capable of capturing at least one of a stream of image or audio data, and delivering to the artificial intelligence processing unit a continuous sequence of images of target or area included in stream;
A cloud server connected to said tracking camera via a communication network and equipped with an independent artificial intelligence processing unit, said cloud server being configured to receive a data stream sent by said tracking camera and pass the received data stream to its own equipped artificial intelligence processing unit for inferencing;
A terminal device configured to be capable of effectively communicating with a trail camera, a cloud server, capable of receiving real-time message notifications of target object-related data from cloud server or camera, wherein target object-related data includes, but is not limited to, at least one frame of image data from a data stream captured by camera, a category of an animal, the size of an animal, the location of an animal, the animal's trajectory, and other information.

10. The trail camera system of claim 9, wherein the trail camera comprises: an image capture module; an image processing module; a central processing module; an artificial intelligence processing module; a power management module; a communication interface; an environment sensing and assisting device, an acoustic and optical repelling device; and a memory;
Wherein the memory is connected to the central processing module, the memory being for storing computer program code or an artificial intelligence model, the computer program code comprising computer instructions, the central processing module invoking computer instructions to cause the trail camera to perform the method of any one of claims 1.

11. The trail camera system of claim 9, wherein in that said trail camera is equipped with an artificial intelligence processing unit comprising, but not limited to:
A content module, which includes, but is not limited to, receiving digital data streams from a plurality of data sources, including an image capturing unit of the tracking camera;
A recognition and analysis module, including but not limited to: processing said data from the content module by an artificial intelligence model deployed by the tracking camera, performing an analysis task on the input data based on the pre-trained artificial intelligence model, including but not limited to target detection, target tracking, and the like.

12. The trail camera system of claim 9, wherein the system is an artificial intelligence agent capable of receiving and analyzing data from the tracking camera or the user end, performing intelligent reasoning and processing based on said data, and generating natural language descriptions in real-time. These descriptions are returned to the camera or the user end and broadcast in the form of audio or text, enabling intelligent interaction with the user and providing personalized feedback and decision-making suggestions.

13. The trail camera system of claim 9, wherein the artificial intelligence processing unit carried by the trail camera and the cloud server may work independently or in concert: both may be analyzed without, at the same time, or by the artificial intelligence processing unit of the trail camera or the artificial intelligence processing unit of the cloud server, respectively.

14. The trail camera system of claim 9, wherein the end device may be various types of devices including, but not limited to, cell phones, tablets, laptops, and the like.

15. The trail camera system of claim 9, wherein the terminal device is set up to be able to communicate effectively with the off-road camera, the cloud server, and the communication method includes but is not limited to 4G communication, WIFI communication.
